(19) United States
(12) Patent Application Publication
(10) Pub. No.: US 2025/0097845 A1
(43) Pub. Date: Mar. 20, 2025

(54) APPARATUS AND WIRELESS COMMUNICATION METHOD

(71) Applicant: PURPLEVINE INNOVATION COMPANY LIMITED, Hong Kong (HK)

(72) Inventor: Yi-Ting LIN, Hong Kong (HK)

(73) Assignee: PURPLEVINE INNOVATION COMPANY LIMITED, Hong Kong (HK)

(21) Appl. No.: 18/727,090

(22) PCT Filed: Jan. 6, 2023
(86) PCT No.: PCT/CN2023/070841

§ 371 Date: Jul. 6, 2024

Related U.S. Application Data
(63) Continuation-in-part of application No. 17/910,365, filed on Oct. 6, 2022.
(60) Provisional application No. 63/266,503, filed on Jan. 6, 2022.
(60) Provisional application No. 63/168,265, filed on Mar. 31, 2021.

(51) Int. Cl. H04W 52/02; H04W 76/28

(52) U.S. Cl. CPC H04W 52/0235; H04W 76/28

(57) ABSTRACT

Apparatuses and wireless communication methods are disclosed. A wireless communication method performed by a user equipment (UE) includes performing a power saving mechanism when the UE is in a discontinuous coverage scenario that includes alternating occurrences of an in-coverage and an out-of-coverage, wherein in the power saving mechanism, the UE is in a dormant state or in a power saving mode (PSM) during the out-of-coverage of the discontinuous coverage scenario and is configured to wake up to monitor a paging during the in-coverage of the discontinuous scenario.

### BACKGROUND OF DISCLOSURE

### 1. Field of the Disclosure

The present disclosure relates to the field of communication systems, and more particularly, to apparatuses and wireless communication methods, which can provide a non-terrestrial communication for Narrowband Internet of Things (NB-IoT), provide a power saving for discontinuous coverage in a IoT non-terrestrial network (NTN), provide a good communication performance, and/or provide high reliability.

### 2. Description of the Related Art

A third-generation partnership project (3GPP) Release 17 (Rel-17) Work Item (WI) on NB-IoT/enhanced Machine Type Communication (eMTC) support for Non-Terrestrial Networks (LTE_NBIOT_eMTC_NTN) was approved. According to objectives of Work Item Description (WID) for Rel-17 IoT NTN, how to enhance existing power saving mechanisms e.g., discontinuous reception (DRX), power saving mode (PSM), extended discontinuous reception (eDRX) for one or more UEs in a discontinuous coverage is an important issue to be resolve.

Therefore, there is a need for apparatuses and wireless communication methods, which can provide a non-terrestrial communication for Narrowband Internet of Things (NB-IoT), provide a power saving for discontinuous coverage in a IoT non-terrestrial network (NTN), provide a good communication performance, and/or provide high reliability.

### SUMMARY

An object of the present disclosure is to propose apparatuses and wireless communication methods, which can provide a non-terrestrial communication for Narrowband Internet of Things (NB-IoT), provide a power saving for discontinuous coverage in a IoT non-terrestrial network (NTN), provide a good communication performance, and/or provide high reliability.

In a first aspect of the present disclosure, a wireless communication method performed by a user equipment (UE) includes performing a power saving mechanism when the UE is in a discontinuous coverage scenario that includes alternating occurrences of an in-coverage and an out-of-coverage, wherein in the power saving mechanism, the UE is in a dormant state or in a power saving mode (PSM) during the out-of-coverage of the discontinuous coverage scenario and is configured to wake up to monitor a paging during the in-coverage of the discontinuous scenario.

In a second aspect of the present disclosure, a wireless communication method performed by a base station includes transmitting a power saving information for a user equipment (UE) in a discontinuous coverage scenario that comprises alternating occurrences of an in-coverage and an out-of-coverage such that the UE can be in a dormant state or in a power saving mode (PSM) during the out-of-coverage of the discontinuous scenario and wakes up to monitor a paging during the in-coverage of the discontinuous scenario.

In a third aspect of the present disclosure, a UE includes an executor configured to perform a power saving mechanism when the UE is in a discontinuous coverage scenario that includes alternating occurrences of an in-coverage and an out-of-coverage, wherein in the power saving mechanism, the UE is in a dormant state or in a power saving mode (PSM) during the out-of-coverage of the discontinuous coverage scenario and is configured to wake up to monitor a paging during the in-coverage of the discontinuous scenario.

In a fourth aspect of the present disclosure, the base station includes a transmitter configured to transmit a power saving information for a user equipment (UE) in a discontinuous coverage scenario that comprises alternating occurrences of an in-coverage and an out-of-coverage such that the UE can be in a dormant state or in a power saving mode (PSM) during the out-of-coverage of the discontinuous scenario and wakes up to monitor a paging during the in-coverage of the discontinuous scenario.

In a fifth aspect of the present disclosure, a UE comprises a memory, a transceiver, and a processor coupled to the memory and the transceiver. The processor is configured to perform the above method.

In a sixth aspect of the present disclosure, a UE comprises a memory, a transceiver, and a processor coupled to the memory and the transceiver. The processor is configured to perform the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1A is a schematic diagram illustrating that a UE is from in-coverage to out-of-coverage of an NTN network when a cell is a moving cell.

FIG. 1B is a schematic diagram illustrating that a UE is from in-coverage to out-of-coverage of an NTN network when a cell is a quasi-earth fixed cell.

FIG. 2 is a schematic diagram illustrating a UE state exchange between RRC connected and PSM according to an embodiment of the present disclosure.

FIG. 3 is a schematic diagram illustrating a UE state exchange between RRC connected and eDRX according to an embodiment of the present disclosure.

FIG. 4 is a block diagram illustrating a system architecture of communication networks according to an embodiment of the present disclosure.

FIG. 5 is a flowchart illustrating a wireless communication method perform by a UE according to an embodiment of the present disclosure.

FIG. 6 is a flowchart illustrating a wireless communication method perform by a base station according to an embodiment of the present disclosure.

FIG. 7 is a schematic diagram illustrating an RLF and RRC connection re-establishment procedure for a UE.

FIG. 8 is a schematic diagram illustrating a PSM configuration for discontinuous coverage according to an embodiment of the present disclosure.

FIG. 9 is a schematic diagram illustrating that an eDRX/PSM cycle is updated during each in-coverage interval according to an embodiment of the present disclosure.

FIG. 10 is a schematic diagram illustrating that based on a broadcast service start/stop time, a UE omits paging opportunities without modifying an eDRX/PSM cycle according to an embodiment of the present disclosure.

FIG. 11 is a schematic diagram illustrating an example of multiple eDRX/PSM configurations for a UE according to an embodiment of the present disclosure.

FIG. 12 is a schematic diagram illustrating a procedure of initial eDRX/PSM configuration(s) through an initial attach according to an embodiment of the present disclosure.

FIG. 13 is a schematic diagram illustrating a procedure of updating eDRX/PSM configuration(s) by a UE-initiated tracking area update procedure according to an embodiment of the present disclosure.

FIG. 14 is a schematic diagram illustrating a procedure of updating eDRX/PSM initiated by an eNB/MME according to an embodiment of the present disclosure.

FIG. 15 is a schematic diagram illustrating an offset value for eDRX configuration according to an embodiment of the present disclosure.

FIG. 16 is a schematic diagram illustrating an offset value for PSM configuration according to an embodiment of the present disclosure.

FIG. 17 is a schematic diagram illustrating a procedure of updating eDRX/PSM by paging a UE according to an embodiment of the present disclosure.

FIG. 18 is a block diagram of a UE for wireless communication according to an embodiment of the present disclosure.

FIG. 19 is a block diagram of a base station for wireless communication according to an embodiment of the present disclosure.

FIG. 20 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

A third-generation partnership project (3GPP) Release 17 (Rel-17) Work Item (WI) on NB-IoT/enhanced Machine Type Communication (eMTC) support for Non-Terrestrial Networks (LTE_NBIOT_eMTC_NTN) was approved. One of the objectives of WID LTE_NBIOT_eMTC_NTN in RAN2 includes: Support of discontinuous coverage without excessive UE power consumption and without excessive failures/recovery actions. Minor enhancements to the existing power saving mechanisms e.g., DRX, PSM, eDRX, relaxed monitoring, and (G)WUS can be considered, and if found needed, specified, to support discontinuous coverage.

The progress from RAN2 #115-e meeting (9-27 Aug. 2021)

RAN2 confirms that the following may be supported: discontinuous coverage without excessive UE power consumption and without excessive failures/recovery actions. It is expected that this needs to be taken into account at least for Idle mode. The requirement is applicable for all reference scenarios (GEO, MEO and LEO).

Satellite assistance information may be used by the UE for predicting coverage discontinuity. The details of the assistance information are for further study (FFS). FFS whether any applicable agreements made in NR-NTN can be reused.

The details of UEs actions when predicted to be discontinuous coverage is FFS, e.g., stopping unnecessary cell search in the Idle mode, and FFS to what extent this need to be specified.

It is FFS to what extent it needs to be specified the details of UE's prediction of discontinuous coverage and its ability to detect when it is back in coverage.

RAN2 sends an LS to SA2 and CT1 (cc: RAN3) for the possible alignment work in their specification due to the support of discontinuous coverage. The progress from RAN2 #116-e meeting (1-12 Nov. 2021)

Satellite Ephemeris Parameters (not the same as for L1 pre-compensation, for the constellation, not just single satellite) is needed for the UE for predicting coverage discontinuity. Other info, e.g., beam info, elevation angle, reference location or corresponding is FFS.

Providing the start-time of (incoming) satellite's coverage and end-time of serving satellite's coverage is needed for Quasi-Earth Fixed satellites.

From RAN2 point of view, the existing power saving mechanisms e.g., DRX, PSM, eDRX, relaxed monitoring, and WUS can be reused in IoT-NTN. Minor enhancements in existing power saving mechanisms to support discontinuous coverage is FFS.

In this invention, some embodiments discuss how to deal with power saving mechanisms, e.g., DRX, eDRX, and/or PSM for a discontinuous coverage scenario of IoT NTN.

In this disclosure, the term “/” can be interpreted to indicate “and/or.” Note that even though eNB is illustrated in the description, the disclosed exemplary method may be executed by any suitable base station, such as gNB. The term “cell” refers to a logical communication entity used for communication with a base station (e.g., over a carrier), and may be associated with an identifier for distinguishing neighboring cells (e.g., a physical cell identifier (PCID), a virtual cell identifier (VCID)) operating via the same or a different carrier. In some examples, a carrier may support multiple cells, and different cells may be configured according to different protocol types (e.g., machine-type communication (MTC), narrowband Internet-of-Things (NB-IoT), enhanced mobile broadband (eMBB), or others) that may provide access for different types of devices.

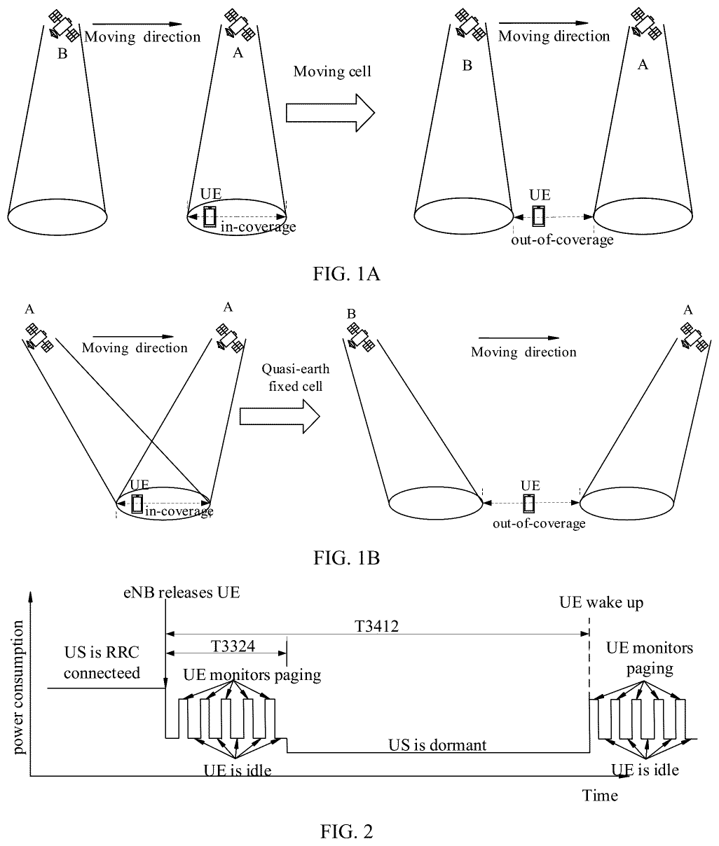

FIG. 1A is a schematic diagram illustrating that a UE is from in-coverage to out-of-coverage of an NTN network when a cell is a moving cell. FIG. 1B is a schematic diagram illustrating that a UE is from in-coverage to out-of-coverage of an NTN network when a cell is a quasi-earth fixed cell. As shown in FIG. 1A for a moving cell and FIG. 1B for a quasi-earth fixed cell, when a satellite A moves forward with time, the UE's state may be from in-coverage to out-of-coverage. Note that a moving cell is a footprint of the satellite that may move when the satellite moves forward relative to a geolocation (reference location), while a quasi-earth fixed cell is a footprint that is fixed when the satellite moves from a specific elevation angle (e.g., 60 degrees) to a specific elevation angle (e.g., 120 degrees) relative to a geolocation (reference location). When the UE is out-of-coverage, there is no signal exchange between the UE and the satellite. The out-of-coverage interval is not deterministic and may be increased or decreased over time. If the out-of-coverage interval could not be precisely predicted/configured, two technical problems may arise as follows:

1. The UE is in an RRC connected state from in-coverage to out-of-coverage. In this case, the UE may encounter radio link failure (RLF) after the satellite A leaves the UE. After the UE enters RLF, the UE continuously performs cell selection to find a cell to re-establish the RRC connection with the coming satellite. However, the out-of-coverage interval may last for several hours, resulting in wasting power for the UE.

2. The UE is in RRC Idle/Inactive state from in-coverage to out-of-coverage. In this case, the UE is usually configured with a power saving mechanism such as eDRX or PSM to periodically wake up to monitor the paging (channel) from the eNB/gNB. Since the interval is not deterministic, the eDRX or PSM for the UE could not be precisely configured such that the UE may wake up during the out-of-coverage or wake up after the next in-overage. If the UE wakes up during the out-of-coverage, the UE may waste power to monitor the non-existent paging (channel). If the UE wakes after the next in-coverage, the UE may miss the paging (channel) from the eNB.

Therefore, how to avoid the unnecessary measurements during out-of-coverage and how to precisely configure and/or adjust the eDRX/PSM configuration(s) based on the out-of-coverage interval is the goal of some embodiments of this invention.

### Technical Problem

1. How does the UE avoid the unnecessary measurements during out-of-coverage?

2. How does the eNB/UE precisely configure and/or adjust the eDRX/PSM configuration(s) based on the out-of-coverage interval?

### Technical Solutions

1. When the UE is in RRC connected state from in-coverage to out-of-coverage, at least one of the followings is performed.

a. Reducing the measurement latency of the serving cell for the UE.

b. Avoiding the UE continuously performing cell (re)selection before re-establishing the connection or reducing the measurement time.

c. Reducing the latency of cell (re)selection.

2. When the UE is in RRC Idle/Inactive state from in-coverage to out-of-coverage, at least one of the followings is performed.

a. The eNB pages the UE to re-configure the eDRX/PSM parameters for the UE.

b. The eNB broadcasts a service stop time of a serving satellite and/or a service start time of a next satellite.

c. The eNB configures the UE with multiple eDRX/PSM configurations.

### Advantageous Effects

Based on the proposed solutions, the UE could be dormant during the out-of-coverage and wake up to monitor the paging during the in-coverage.

### Power Saving Mode (PSM)

PSM is a power saving mechanism which is released in 3GPP Release 12 for enhanced Machine Type Communications (eMTC) or Narrowband Internet of Things (NB-IoT) UEs. The UE requests an Active Time (i.e., T3324 and T3412 timers) by Attach or Tracking Area Update (TAU) or Routing Area Update (RAU) procedures. After being released from the RRC connected state, the UE enters normal idle mode and activates timers T3324 and T3412. During the normal idle mode, the UE performs discontinuous reception (DRX) to monitor the paging until T3324 expires. If the UE is not paged during T3324, the UE enters power saving mode and turns off all the non-critical functionality until the T3412 expires. During the power saving mode, the UE will not monitor the paging (channel) such that the UE is not reachable by the eNB/core networks (CN). A UE state exchange between RRC connected and PSM is shown in FIG. 2. According to the values of T3412 specified in TS 24.008, the maximum of T3412 is 320 hours * 32=10240 hours ≈426.67 days. The maximum of T3324 is 186 minutes.

### Extended Discontinuous Reception (eDRX)

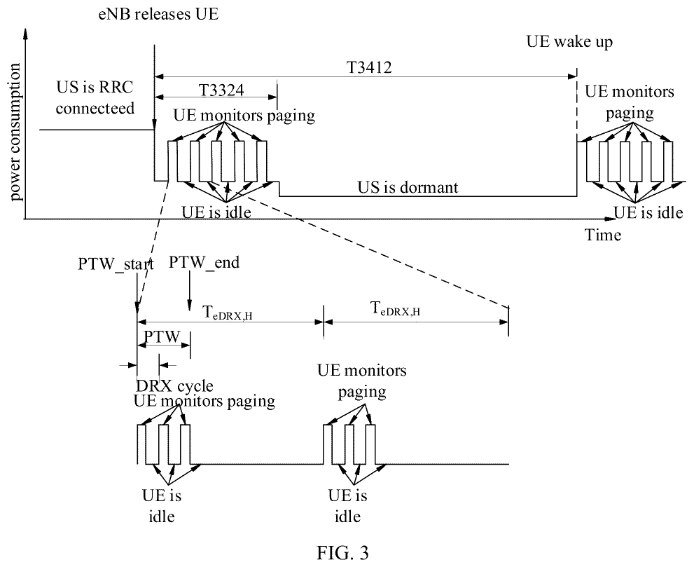

eDRX is another power saving mechanism which is released in 3GPP Release 12 primary for eMTC or NB-IoT UEs. The UE requests an eDRX parameters (i.e., eDRX cycle, T_{eDRX,H} and Paging Time Window (PTW) length, L defined in TS 24.008) by Attach or TAU/RAU procedures. After being released from the RRC connected state, the UE enters normal idle mode at the system frame number, PTW_start. During the Paging Time Window (PTW), the UE performs DRX to monitor the paging until PTW_end. A UE state exchange between RRC connected and eDRX is shown in FIG. 3. According to the values specified in TS 24.008, the maximum of T_{eDRX,H} is 10.24 seconds (maximum 1024 radio frames)*1024 (maximum 1024 Hyper-frames for NB-IoT)=10485.76 seconds≈2.91 hours. For eMTC, the maximum of T_{eDRX,H} is 10.24 seconds (maximum 1024 radio frames) * 256 (maximum 256 Hyper-frames for eMTC)=2621.44 seconds≈43.69 minutes. The maximum of PTW length is 40.96 seconds for NB-IoT and 20.48 seconds for eMTC. System architecture of 4G/5G communication networks

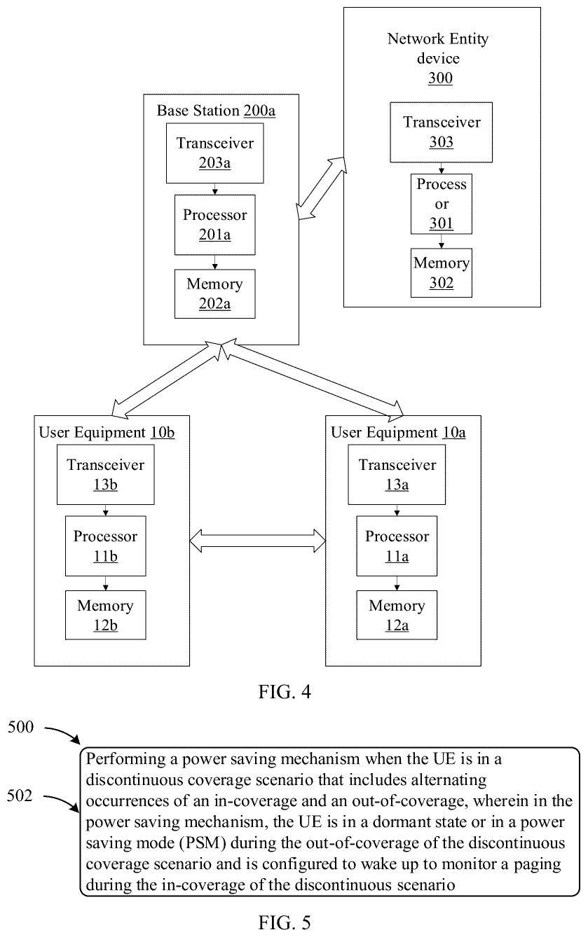

FIG. 4 is a block diagram illustrating a system architecture of communication networks according to an embodiment of the present disclosure.

With reference to FIG. 4, a UE 10a, a UE 10b, a base station 200a, and a network entity device 300 executes embodiments of the method according to the present disclosure. Connections between devices and device components are shown as lines and arrows in the FIG. 4. The UE 10a may include a processor 11a, a memory 12a, and a transceiver 13a. The UE 10b may include a processor 11b, a memory 12b, and a transceiver 13b. The base station 200a may include a processor 201a, a memory 202a, and a transceiver 203a. The network entity device 300 may include a processor 301, a memory 302, and a transceiver 303. Each of the processors 11a, 11b, 201a, and 301 may be configured to implement proposed functions, procedures and/or methods described in this description. Layers of radio interface protocols may be implemented in the processors 11a, 11b, 201a, and 301. Each of the memory 12a, 12b, 202a, and 302 operatively stores a variety of program and information to operate a connected processor. Each of the transceiver 13a, 13b, 203a, and 303 is operatively coupled with a connected processor, transmits and/or receives radio signals. The base station 200a may be an eNB, a gNB, or one of other radio nodes.

Each of the processor 11a, 11b, 201a, and 301 may include a general-purpose central processing unit (CPU), an application-specific integrated circuits (ASICs), other chipsets, logic circuits and/or data processing devices. Each of the memory 12a, 12b, 202a, and 302 may include a read-only memory (ROM), a random access memory (RAM), a flash memory, a memory card, a storage medium, other storage devices, and/or any combination of the memory and storage devices. Each of the transceiver 13a, 13b, 203a, and 303 may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The network entity device 300 may be a node in a central network (CN). CN may include LTE CN or 5G core (5GC) which may include user plane function (UPF), session management function (SMF), access and mobility management function (AMF), unified data management (UDM), policy control function (PCF), control plane (CP)/user plane (UP) separation (CUPS), authentication server function (AUSF), network slice selection function (NSSF), the network exposure function (NEF), and other network entities. In some examples, the CN may include a 4G core (4GC). The 4GC may be an example of an evolved packet core (EPC), which may include at least one mobility management entity (MME), at least one serving gateway (SGW), and at least one packet data network (PDN) gateway (PGW). MME may provide mobility management functions for the 4G network. nodes within the 4GC may be interconnected by one or more core network interfaces.

In some embodiments, the processor 11a or 11b is configured to perform a power saving mechanism when the UE 10a or 10b is in a discontinuous coverage scenario that includes alternating occurrences of an in-coverage and an out-of-coverage, wherein in the power saving mechanism, the UE 10a or 10b is in a dormant state or in a power saving mode (PSM) during the out-of-coverage of the discontinuous coverage scenario, and the processor 11a or 11b is configured to wake up to monitor a paging during the in-coverage of the discontinuous scenario. The dormant state may refer to a state in which the UE has no data to be transmitted during the out-of-coverage of the discontinuous coverage scenario. This can solve issues in the prior art, provide a non-terrestrial communication for Narrowband Internet of Things (NB-IoT), provide a power saving for discontinuous coverage in a IoT non-terrestrial network (NTN), provide a good communication performance, and/or provide high reliability. The UE could be dormant during the out-of-coverage and wake up to monitor the paging during the in-coverage.

In some embodiments, the transceiver 203a is configured to transmit a power saving information for the UE 10a or 10b in a discontinuous coverage scenario that includes alternating occurrences of an in-coverage and an out-of-coverage such that the UE 10a or 10b can be in a dormant state or in a power saving mode (PSM) during the out-of-coverage of the discontinuous scenario and wakes up to monitor a paging during the in-coverage of the discontinuous scenario. This can solve issues in the prior art, provide a non-terrestrial communication for Narrowband Internet of Things (NB-IoT), provide a power saving for discontinuous coverage in a IoT non-terrestrial network (NTN), provide a good communication performance, and/or provide high reliability. The UE could be dormant during the out-of-coverage and wake up to monitor the paging during the in-coverage.

FIG. 5 illustrates a wireless communication method 500 perform by a UE according to an embodiment of the present disclosure. In some embodiments, the method 500 includes: a block 502, performing a power saving mechanism when the UE is in a discontinuous coverage scenario that includes alternating occurrences of an in-coverage and an out-of-coverage, wherein in the power saving mechanism, the UE is in a dormant state or in a power saving mode (PSM) during the out-of-coverage of the discontinuous coverage scenario and is configured to wake up to monitor a paging during the in-coverage of the discontinuous scenario. The dormant state may refer to a state in which the UE has no data to be transmitted during the out-of-coverage of the discontinuous coverage scenario. This can solve issues in the prior art, provide a non-terrestrial communication for Narrowband Internet of Things (NB-IoT), provide a power saving for discontinuous coverage in a IoT non-terrestrial network (NTN), provide a good communication performance, and/or provide high reliability. The UE could be dormant during the out-of-coverage and wake up to monitor the paging during the in-coverage.

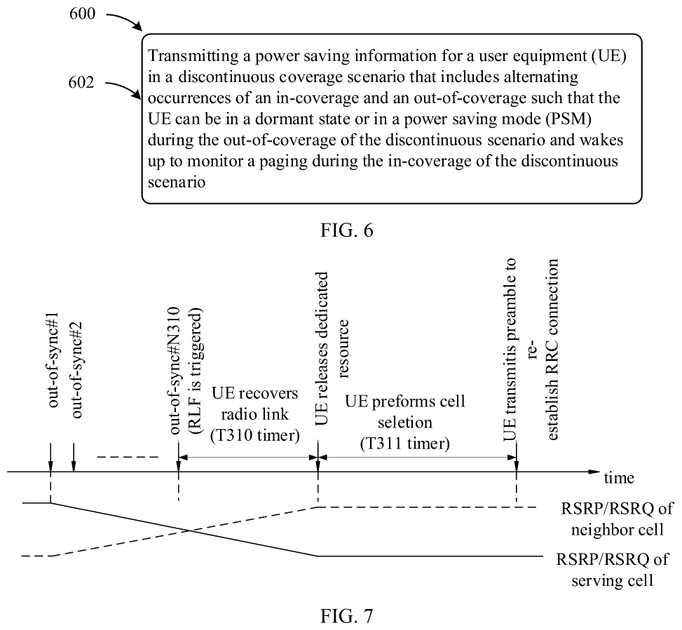

FIG. 6 illustrates a wireless communication method 600 perform by a base station according to an embodiment of the present disclosure. In some embodiments, the method 600 includes: a block 602, transmitting a power saving information for a user equipment (UE) in a discontinuous coverage scenario that comprises alternating occurrences of an in-coverage and an out-of-coverage such that the UE can be in a dormant state or in a power saving mode (PSM) during the out-of-coverage of the discontinuous scenario and wakes up to monitor a paging during the in-coverage of the discontinuous scenario. The dormant state may refer to a state in which the UE has no data to be transmitted during the out-of-coverage of the discontinuous coverage scenario. This can solve issues in the prior art, provide a non-terrestrial communication for Narrowband Internet of Things (NB-IoT), provide a power saving for discontinuous coverage in a IoT non-terrestrial network (NTN), provide a good communication performance, and/or provide high reliability. The UE could be dormant during the out-of-coverage and wake up to monitor the paging during the in-coverage.

### EXAMPLES

The UE is in RRC connected state from in-coverage to out-of-coverage.

In this case, the UE may not finish the data transmission before entering out-of-coverage. After the satellite moves forward, the Reference Signal Received Power (RSRP) and Reference Signal Received Quality (RSRQ) measured by the UE may be gradually decreased and eventually cause the UE to trigger RLF. (i.e., after receiving number of N310 consecutive out-of-sync from the physical layer and the value of N310 could be pre-configured by the eNB) After declaring RLF, the UE triggers a timer T310 and tries to recover the connection until the timer T310 expires, which is depicted in FIG. 7. After the timer T310 expires which means it's impossible to recover the connection with the serving cell, the UE performs RRC re-establishment procedure to select a suitable cell to camp on (i.e., cell (re) selection procedure) and re-establishes the RRC connection with the suitable cell to continue the data transmission. Because of the out-of-coverage interval may last for several hours, it is a waste of power to let the UE continuously perform radio recovery and cell (re)selection. To avoid the waste of power, some mechanisms may be applied for the UE.

Reducing the measurement latency of the serving cell for the UE

Because the satellite may leave after all, it is useless to waste power to measure the serving cell to recover the connection. In addition, the recovery time (i.e., timer T310) may last for several seconds (i.e., the maximum is 8 seconds), it is useful to reduce or early stop the timer T310 based on the received information from the satellite. If the cell is a quasi-earth fixed cell, the information may include service stop time of the satellite, leaving indication, etc. If the cell is a moving cell, the information may include ephemeris information, the reference location (i.e., cell center) of the cell, and/or the cell footprint size (i.e., the radius of the cell). The information may be transmitted to the UE through broadcast message(s) or unicast message(s). Based on the information, the UE could predict when the satellite leaves the UE. After receiving the information, the UE may configure with a shorter timer, named T310′, to reduce the recovery time for the leaving serving cell. In another embodiment, the UE may early stop the timer T310 without adopting the shorter timer T310′.

Avoiding the UE continuously performing cell (re)selection before re-establishing the connection or reducing the measurement time

As per the legacy UE behavior, the UE should continuously perform cell (re)selection until one or more cell(s) is discovered after the timer T310′ expires. Because of the out-of-coverage interval may last for several hours and no cells could be discovered during the out-of-coverage interval, continuously performing cell (re)selection has huge impact on the power consumption of the UE. Some mechanisms could be applied for the UE.

The eNB gives the UE the information of the arrival time of the next satellite. The information may be transmitted to the UE through broadcast message(s) or unicast message(s).

After the timer T310′ expires, the UE could delay the cell (re)selection until a few seconds before the arrival time of the next satellite.

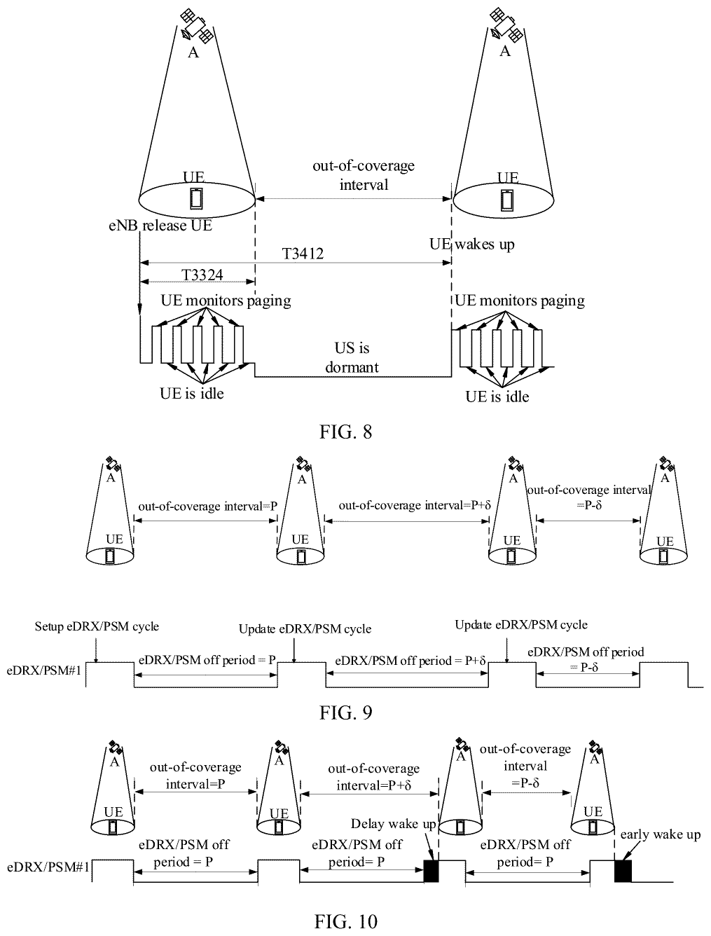

The eNB/MME gives the UE the parameters of eDRX and/or PSM. The parameters may include Paging Time Window (PTW), eDRX cycle, T3324, T3412, etc. The parameters may be updates (e.g., new parameters or offset) of previously configured parameters. The parameters could be transmitted through unicast message such as RRCConnectionReconfiguration, DLInformation Transfer or RRCConnectionRelease messages. The eNB/MME should transmit the parameters of eDRX/PSM before releasing the UE, and then release the UE based on the service stop time. After receiving the RRCConnectionRelease message from the eNB, the UE enters eDRX/PSM (or refer to the UE activates eDRX/PSM configuration(s)) and could stop performing cell (re)selection measurements during the out-of-coverage interval. FIG. 8 shows an example of PSM configuration for discontinuous coverage.

### Reducing the Latency of Cell (re)selection

To reduce the latency of cell (re)selection measurement (i.e., the maximum is 120 seconds), the eNB may send to the UE with the information of the next satellite through unicast or broadcast message. For unicast message, the eNB may send the cell identities or satellite identity of the next satellite through the RRCConnectionRelease message. For broadcast message, the eNB may send the information through system information. (e.g., SystemInformationBlockType4 or SystemInformationBlockType5).

The UE is in RRC Idle/Inactive state from in-coverage to out-of-coverage.

For the NB-IoT UE, the UE stays in RRC Idle/Inactive state most of the time. When the UE stays in RRC Idle/Inactive state, it periodically monitors the paging (channel) based on the configuration(s) of eDRX/PSM. The UE should wake up from the sleep mode (power saving mode) during the in-coverage interval and go to sleep (power saving mode) during the out-of-coverage interval. However, the out-of-coverage interval may be not a perfect periodical interval. The mismatch between the eDRX/PSM off period and the out-of-coverage interval may cause the UE to wake up during the out-of-coverage interval and go to sleep (power saving mode) during the in-coverage interval. Therefore, it is useful to re-configure the eDRX/PSM cycle to maintain the synchronization between the eDRX/PSM off period and the out-of-coverage interval. Some re-configuration mechanisms may be applied for the UE.

The eNB/MME pages the UE to re-configure the eDRX/PSM parameters for the UE:

In this case, eNB/MME pages the UE during the in-coverage interval so that the UE enters RRC connected state. The eNB/MME may transmit the parameters of eDRX and/or PSM to the UE through RRCConnectionReconfiguration, DLInformationTransfer or RRCConnectionRelease messages. eNB/MME means that the MME transmits the paging and/or eDRX/PSM parameters to the UE through the eNB. In addition, when the UE determines that the eDRX/PSM configuration(s) needs to be modified based on a timer or the service stop time of the serving satellite and/or the service start time of the subsequent satellite(s), the UE may request new parameters (or offset of the parameters) of eDRX and/or PSM to the MME through RRCConnectionSetupComplete, ULInformationTransfer, or UEAssistanceInformation messages. The parameters of eDRX/PSM are controlled by the MME. The offset value of the eDRX/PSM configuration is a NAS level parameter. The advantage of this mechanism is that it has less impact on the 3GPP standard specifications. However, this mechanism needs the UE to enter RRC connected state during each in-coverage interval so that consume more power. Take FIG. 9 as an example, the eDRX/PSM cycle is modified to initial period p plus offset δ when the UE is in coverage so that the on period and off period of the eDRX/PSM configuration could match the in-coverage interval and the out-of-coverage interval, respectively.

The eNB broadcasts a service stop time of the serving satellite and/or service start time of

the next satellite.

In this case, the UE stays in RRC Idle/Inactive state and monitors the control information from the eNB. The UE may receive broadcast information from the eNB to calculate (update) the eDRX/PSM cycle by itself. The information may include the service stop time of the serving satellite and/or the arrival time of the next satellite. In another embodiment, the information may be a countdown timer (e.g., 24 hours) for updating the eDRX/PSM configuration(s). Based on the information, when the UE determines the eDRX/PSM cycle(s) needs to be modified to match the service stop time of the serving satellite and/or the service start time of the next satellite, it requests new parameters of eDRX/PSM to the MME through RRCConnectionSetupComplete, ULInformationTransfer, or UEAssistanceInformation messages. Based on the information, the UE could take actions, for example, omitting the paging opportunities to avoid meaningless measurements during the out-of-coverage interval. Take FIG. 10 as an example, by receiving the service start time of the next arrival of the satellite A, the UE could delay the wake-up time to monitor the paging channel. In addition, by receiving the service stop time of the serving satellite A, the UE may go to sleep early.

The MME configures the UE with multiple eDRX/PSM configurations.

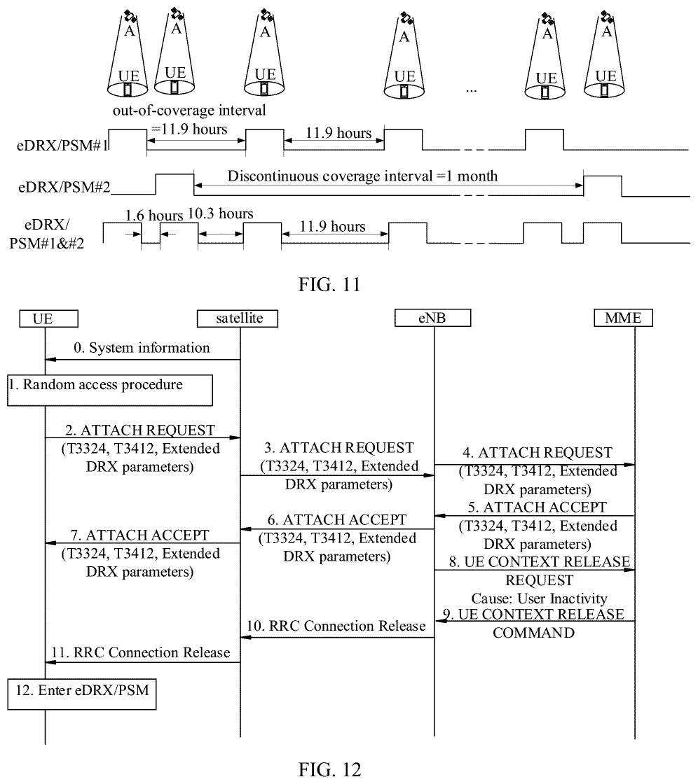

Based on the analyses of the above description, most of the out-of-coverage interval varies between 9 to 13.3 hours with a mean of 11.9 hours while a very short interval of 1.6 hours occurs around once a month. Multiple eDRX/PSM configurations could be configured for the UE to deal with the very short interval. Take FIG. 11 as an example, the out-of-coverage interval of 11.9 hours is configured for eDRX/PSM #1 configuration and the out-of-coverage interval of 1 month for eDRX/PSM #2 configuration. By combining eDRX/PSM #1 and #2 configurations, the UE could be configured with aperiodic out-of-coverage intervals, such as 1.6 hours, 10.3 hours, and 11.9 hours. Note that eDRX/PSM #1 and #2 configurations could be configured for the same satellite or for different satellites with different out-of-coverage intervals. The advantage of this mechanism is that the UE could stay in RRC Idle/Inactive state without entering RRC connected state to modify the eDRX/PSM cycles so that power consumption could be reduced.

The eNB broadcasts the offset(s) of the eDRX/PSM configuration(s).

Because of the mismatch between the eDRX PTW (or PSM timerT3324) and the in-coverage interval of the satellite, the UE may start the paging monitoring too early even when the satellite has not covered the UE's area or start the paging monitoring too late when the satellite is leaving the UE's area. Although the eDRX/PSM configuration(s) could be re-configured by attach or TAU procedures, the UE needs to enter RRC connected which results in a lot of signaling exchange and power consumption. If the mismatch is not great, (e.g., the eDRX PTW or PSM time T3324 also overlaps with the in-coverage interval) it is power efficient to fine-tune the parameters of eDRX/PSM by broadcasting a common offset of the parameters for the UEs in a specific area. The common offset may be a timing offset of the eDRX PTW or PSM timer T3324 for the serving satellite or the timing offset of the eDRX PTW or PSM timer T3324 for the next satellite, and the timing offset value may be positive or negative. The common offset may be a timing offset of the service stop time of the serving satellite or a timing offset of the service start time of the next satellite. The common offset may be an AS level parameter which is different from of the NAS level parameter. Based on the received common offset from the serving satellite, the UEs in the specific area could extend or shorten the eDRX PTW or PSM timer T3324 for the serving satellite (i.e., while the eDRX cycle or PSM T3412 is not changed) without entering RRC connected state. The UEs could also extend or shorten the eDRX PTW or PSM timer T3324 for the next satellite based on the received common offset for the next satellite.

The procedures of eDRX/PSM configuration(s) for a UE

Note that even though the sequence of the steps is illustrated in the following figures, the steps may be executed by different sequence, or the steps in different scenarios may be combined with each other. (e.g., system information broadcasting and paging message broadcasting). Initial configuration(s) of eDRX/PSM

FIG. 12 shows the procedure of initial eDRX/PSM configuration(s) through initial attach. The procedure of initial eDRX/PSM configuration(s) includes at least one of the following steps.

Step 0: The UE receives the broadcast system information from the eNB.

Note 1: For a quasi-earth fixed cell, the system information may include the service stop time of the serving satellite and the service start time of the next satellite.

Note 2: For a moving cell, the service stop time of the serving satellite and service start time of the next satellite may vary for the UEs with different locations. The system information may include ephemeris information, the reference location (i.e., cell center) of the cell, elevation angle, maximum distance, and/or the cell footprint size (i.e., the radius of the cell).

Note 3: The system information may comprise the physical cell identity, satellite identity, or satellite ephemeris of the serving satellite and the next satellite.

Step 1: The UE completes the random access procedure based on the service stop time of the serving satellite.

Note 1: If there is not enough time to complete the random access (i.e., the serving satellite is going to leave the UE's coverage), the UE should avoid starting the random access procedure.

Step 2: The UE transmits the Non-Access Stratum (NAS) message: ATTACH REQUEST message to the serving satellite. The ATTACH REQUEST message is carried in RRC: RRCConnectionSetupComplete or ULInformationTransfer message. The ATTACH REQUEST message may include the parameters of eDRX/PSM such as PTW and T_{eDRX,H} for eDRX and T3324 and T3412 for PSM. The length of PTW or T3324 could be configured as the in-coverage interval of the serving satellite, and the length of T_{eDRX,H} and T3412 could be configured as the in-coverage interval plus the out-of-coverage interval. The out-of-coverage interval could be configured as the service start time of the next satellite minus the service stop time of the serving satellite.

Note 1: The NAS message: ATTACH REQUEST message may include the service stop time of the serving satellite and service start time of the next satellite. The NAS message: ATTACH REQUEST message may also include UE location information, cell identity, satellite identity, or satellite ephemeris. The information is for Mobility Management Entity (MME) to determine the values of T3324 and T3412.

Note 2: The ATTACH REQUEST message may include the parameters of multiple eDRX/PSM configurations.

Step 3: The satellite forwards the ATTACH REQUEST message to the eNB.

Note 1: If the satellite is a regenerative satellite (i.e., the eNB is implemented on the satellite), this step could be omitted. If the satellite is a transparent satellite (i.e., the eNB is implemented on the ground and connect with the UE through the satellite), the satellite just forwards the ATTACH REQUEST message to the eNB through the feeder link.

Step 4: The eNB forwards the ATTACH REQUEST message to the MME. The

ATTACH REQUEST message is carried in the S1AP: Initial UE message.

Step 5: The MME replies with the ATTACH ACCEPT message to the eNB. The ATTACH ACCEPT message is carried in the S1AP: Initial Context Setup Request message. The ATTACH ACCEPT message includes the parameters of eDRX/PSM (i.e., PTW and T_{eDRX,H} for eDRX and T3324 and T3412 for PSM) if the MME accepts the eDRX/PSM request from the UE.

Note 1: If the countdown timer for the eDRX/PSM configuration(s) validation is configured by the MME, the MME transmits the countdown timer in the ATTACH ACCEPT message.

Step 6: The eNB forwards the ATTACH ACCEPT message to the satellite. The ATTACH ACCEPT message may be carried in the RRC: RRCConnectionReconfiguration or DLInformation Transfer message.

Note 1: If the satellite is a regenerative satellite, this step could be omitted.

Note 2: If the countdown timer for the eDRX/PSM configuration(s) validation is configured by the eNB, the eNB transmits the countdown timer in the RRC: RRCConnectionReconfiguration message.

Step 7: The satellite forwards the ATTACH ACCEPT message to the UE. The ATTACH in RRC: RRCConnectionReconfiguration or ACCEPT message may be carried

DLInformation Transfer message. After receiving the ATTACH ACCEPT message, the UE setups the eDRX/PSM configuration(s) for the default radio bearer.

Note 1: If the UE requests multiple eDRX/PSM configurations in step 2, the ATTACH ACCEPT message may include the parameters of multiple eDRX/PSM configurations.

Note 2: When the UE receives the countdown timer for the eDRX/PSM configuration(s) validation, the UE activates the countdown timer for the eDRX/PSM configuration(s).

Step 8: After the data transmission, the eNB may transmit the S1AP: UE CONTEXT RELEASE REQUEST message with cause value: “User Inactivity” to the MME to initiate to release the radio bearer for the UE.

Note 1: This step is optional and may be omitted when the MME initiates to release the

UE.

Note 2: The eNB should transmit the S1AP: UE CONTEXT RELEASE REQUEST message before the service stop time of the serving satellite of the UE.

Note 3: The S1AP: UE CONTEXT RELEASE REQUEST message may include the service stop time of the serving satellite of the UE.

Note 4: The cause value may be a new one (e.g., “Discontinuous Coverage”) other than any existing ones.

Step 9: The MME transmits the S1AP: UE CONTEXT RELEASE COMMAND message to the eNB to release the UE.

Note 1: If the MME has the information about the service stop time of the serving satellite

and service start time of the next satellite, it may initiate the S1AP: UE CONTEXT RELEASE COMMAND message to the UE through the eNB.

Step 10: The eNB transmits RRCConnectionRelease message to the satellite to release the UE.

Note 1: The RRCConnectionRelease message may comprise a ReleaseCause. (e.g., Discontinuous Coverage).

Step 11: The satellite forwards the RRCConnectionRelease message to the UE.

Step 12: After receiving the RRCConnectionRelease message, the UE goes to RRC Idle and activates eDRX/PSM operation.

Note 1: The UE may skip monitoring the paging during the out-of-coverage interval.

Updating configuration(s) of eDRX/PSM Updating eDRX/PSM configuration(s) by the UE

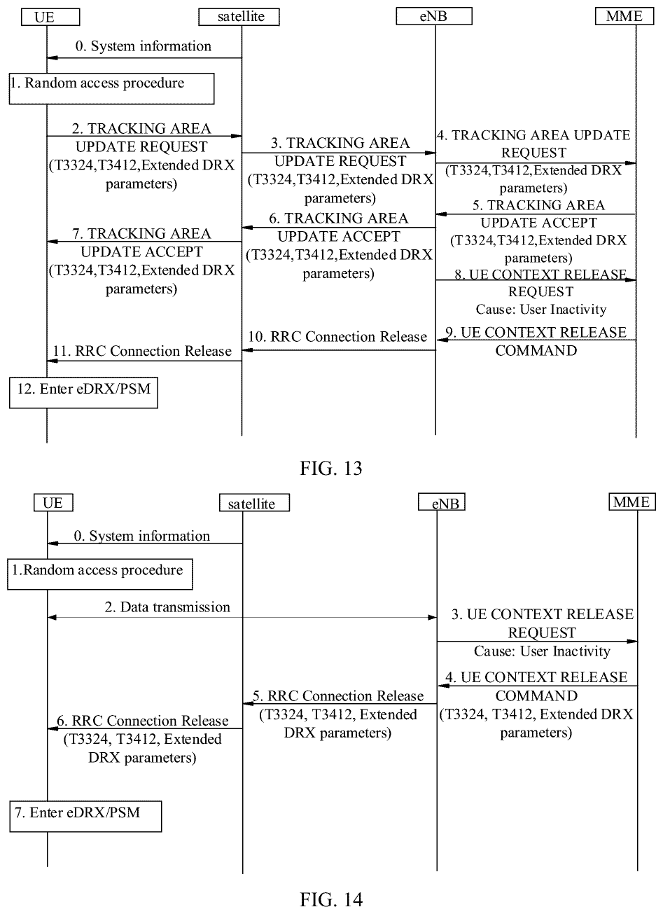

FIG. 13 shows the procedure of updating eDRX/PSM configuration(s) by UE-initiated

tracking area update procedure. The procedure of updating eDRX/PSM initiated by the UE includes at least one of the following steps.

Step 0: The UE receives the broadcast system information from the eNB.

Note 1: For a quasi-earth fixed cell, the system information may include the service stop time of the serving satellite and the service start time of the next satellite.

Note 2: For a moving cell, the service stop time of the serving satellite and service start time of the next satellite may vary for the UEs with different locations. The system information may include ephemeris information, the reference location (i.e., cell center) of the cell, and/or the cell footprint size (i.e., the radius of the cell).

Note 3: The system information may comprise the physical cell identity, satellite identity, or satellite ephemeris of the serving satellite and the next satellite.

Step 1: When the UE determines that the service stop time of the serving satellite is outside (after) the active time of the current eDRX/PSM periodicity or the service start time of the next satellite is outside (before/after) the active time of the subsequent eDRX/PSM periodicity, the UE may initiate the random access procedure to update the eDRX/PSM configuration(s).

Note 1: If there is not enough time to complete the random access (i.e., the serving satellite is going to leave the UE's coverage), the UE may avoid starting the random access procedure.

Note 2: If the UE is configured with the countdown timer for the eDRX/PSM configuration(s) validation, the UE may initiate the random access procedure to update the eDRX/PSM configuration(s) when the countdown timer counts down to zero.

Step 2: The UE transmits the NAS message: TRACKING AREA UPDATE REQUEST message to the serving satellite. The TRACKING AREA UPDATE REQUEST message is carried in RRC: RRCConnectionSetupComplete or ULInformationTransfer message. The TRACKING AREA UPDATE REQUEST message may include the updated parameters of eDRX/PSM such as PTW and T_{eDRX,H} for eDRX and T3324 and T3412 for PSM. The length of PTW or T3324 could be configured as the in-coverage interval of the serving satellite, and the length of T_{eDRX,H} and T3412 could be configured as the in-coverage interval plus the out-of-coverage interval. The out-of-coverage interval could be configured as the service start time of the next satellite minus the service stop time of the serving satellite.

Note 1: the NAS message: TRACKING AREA UPDATE REQUEST message may include the service stop time of the serving satellite and service start time of the next satellite. The NAS message: TRACKING AREA UPDATE REQUEST message may also include UE location information, cell identity, satellite identity, or satellite ephemeris. The information is for MME to determine the values of T3324 and T3412.

Note 2: The ATTACH REQUEST message may include the parameters of multiple eDRX/PSM configurations.

Step 3: The satellite forwards the TRACKING AREA UPDATE REQUEST message to the eNB.

Note 1: If the satellite is a regenerative satellite (i.e., the eNB is implemented on the satellite), this step could be omitted. If the satellite is a transparent satellite (i.e., the eNB is implemented on the ground and connect with the UE through the satellite), the satellite just forwards the TRACKING AREA UPDATE REQUEST message to the eNB through the feeder link.

Step 4: The eNB forwards the TRACKING AREA UPDATE REQUEST message to the MME. The TRACKING AREA UPDATE REQUEST message is carried in the S1AP: Initial UE message.

Step 5: The MME replies with the TRACKING AREA UPDATE ACCEPT message to the eNB. The TRACKING AREA UPDATE ACCEPT message is carried in the S1AP: Initial Context Setup Request message. The TRACKING AREA UPDATE ACCEPT message includes the parameters of eDRX/PSM (i.e., PTW and T_{eDRX,H} for eDRX and T3324 and T3412 for PSM) if the MME accepts the eDRX/PSM request from the UE.

Note 1: If the countdown timer for the eDRX/PSM configuration(s) validation is configured by the MME, the MME may update the countdown timer in the TRACKING AREA UPDATE ACCEPT message.

Step 6: The eNB forwards the TRACKING AREA UPDATE ACCEPT message to the satellite. The TRACKING AREA UPDATE ACCEPT message is carried in the RRC: RRCConnectionReconfiguration or DLInformationTransfer message.

Note 1: If the satellite is a regenerative satellite (i.e., the eNB is implemented on the satellite), this step could be omitted.

Note 2: If the countdown timer for the eDRX/PSM configuration(s) validation is configured by the eNB, the eNB may update the countdown timer in the RRC: RRCConnectionReconfiguration message.

Step 7: The satellite forwards the TRACKING AREA UPDATE ACCEPT message to the UE. The TRACKING AREA UPDATE ACCEPT message is carried in RRC: RRCConnectionReconfiguration or DLInformationTransfer message. After receiving the TRACKING AREA UPDATE ACCEPT message, the UE updates the eDRX/PSM configuration(s) for the default radio bearer.

Note 1: If the UE requests multiple eDRX/PSM configurations in step 2, the TRACKING AREA UPDATE ACCEPT message may include the parameters of multiple eDRX/PSM configurations.

Note 2: When the UE receives the (updated) countdown timer for the eDRX/PSM configuration(s) validation, the UE activates the countdown timer for the eDRX/PSM configuration(s).

Step 8: After the data transmission, the eNB may transmit the S1AP: UE CONTEXT RELEASE REQUEST message with cause value: “User Inactivity” to the MME to initiate to release the radio bearer for the UE.

Note 1: This step is optional and may be omitted when the MME initiates to release the UE.

Note 2: The eNB should transmit the S1AP: UE CONTEXT RELEASE REQUEST message before the service stop time of the serving satellite of the UE.

Note 3: The S1AP: UE CONTEXT RELEASE REQUEST message may include the service stop time of the serving satellite of the UE.

Note 4: The cause value may be a new one (e.g., “Discontinuous Coverage”) other than

any existing ones.

Step 9: The MME transmits the S1AP: UE CONTEXT RELEASE COMMAND message to the eNB to release the UE.

Note 1: If the MME has the information about the service stop time of the serving satellite and service start time of the next satellite, it may initiate the S1AP: UE CONTEXT RELEASE

COMMAND message to the UE through the eNB.

Step 10: The eNB transmits RRCConnectionRelease message to the satellite to release the UE.

Note 1: The RRCConnectionRelease message may comprise a ReleaseCause. (e.g., Discontinuous Coverage).

Step 11: The satellite forwards the RRCConnectionRelease message to the UE.

Step 12: After receiving the RRCConnectionRelease message, the UE goes to RRC Idle and activates eDRX/PSM operation using the updated eDRX/PSM configuration(s).

Note 1: The UE may skip monitoring the paging during the out-of-coverage interval.

Updating eDRX/PSM configuration(s) by the eNB/MME

FIG. 14 shows the procedure of updating eDRX/PSM configuration(s) by eNB/MME-initiated release procedure. In this embodiment, the eDRX/PSM configuration(s) modification is controlled by the eNB/MME. The procedure of updating eDRX/PSM initiated by the eNB/MME includes at least one of the following steps.

Step 0: The UE receives the broadcast system information from the eNB. In this case, the system information may not include the service stop time of the serving satellite and service start time of the next satellite because the eNB/MME controls and initiates the configuration of eDRX/PSM.

Note 1: The system information may comprise the physical cell identity, satellite identity,

or satellite ephemeris of the serving satellite and the next satellite.

Step 1: The UE completes the random access procedure.

Step 2: The UE performs data transmission to/from the eNB.

Step 3: After the data transmission, the eNB may transmit the S1AP: UE CONTEXT RELEASE REQUEST message with cause value: “User Inactivity” to the MME to initiate to release the radio bearer for the UE.

Note 1: This step is optional and may be omitted when the MME initiates to release the UE.

Note 2: The eNB should transmit the S1AP: UE CONTEXT RELEASE REQUEST message before the service stop time of the serving satellite of the UE.

Note 3: The S1AP: UE CONTEXT RELEASE REQUEST message may include the service stop time of the serving satellite of the UE and the service start time of the next satellite. The S1AP: UE CONTEXT RELEASE REQUEST message may also include UE location information, cell identity, satellite identity, or satellite ephemeris.

Note 4: The cause value may be a new one (e.g., “Discontinuous Coverage”) other than

any existing ones.

Step 4: The MME transmits the S1AP: UE CONTEXT RELEASE COMMAND message to the eNB to release the UE. If the MME determines that the eDRX/PSM need to be updated based on UE location, cell identity, satellite identity, satellite ephemeris, the service stop time of the serving satellite of the UE and/or the service start time of the next satellite, it may transmit the updated parameters of eDRX/PSM such as PTW and T_{eDRX,H} for eDRX and T3324 and T3412 for PSM in the UE CONTEXT RELEASE COMMAND message.

Note 1: If the MME has the information about the service stop time of the serving satellite and service start time of the next satellite, it may initiate the S1AP: UE CONTEXT RELEASE COMMAND message to the UE through the eNB.

Note 2: The S1AP: UE CONTEXT RELEASE COMMAND message may include the parameters of multiple eDRX/PSM configurations.

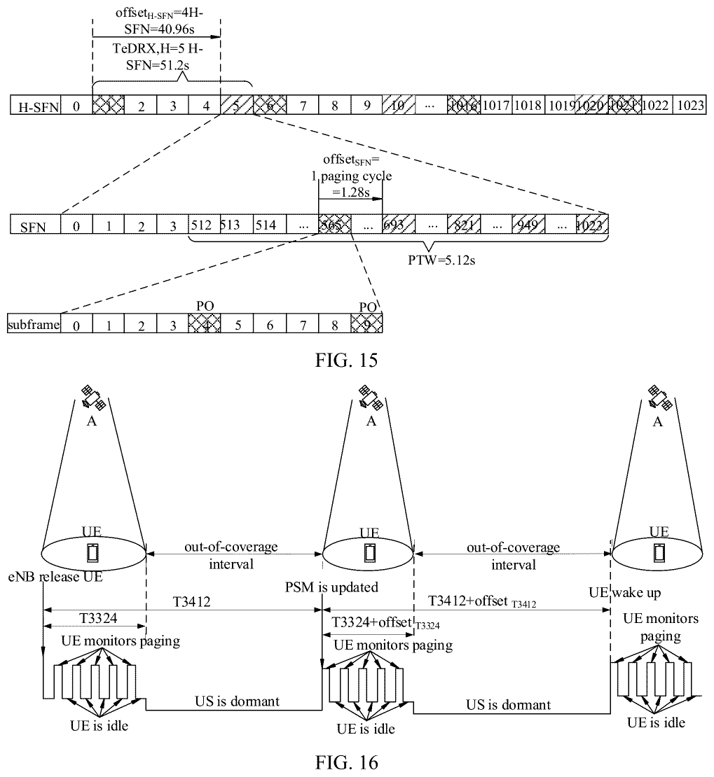

Note 3: The parameters of eDRX transmitted in the UE CONTEXT RELEASE COMMAND message may be an offset of the previously configured eDRX parameters. Take FIG. 15 as an example of the offset for eDRX configuration, the offset may be an offset (e.g., offset_{H-SFN}) of Hyper system frame number (H-SFN) which is 10.24 s long when HSFN increases by one. The offset may be an offset (e.g., offset_{SFN}) of system frame number (SFN) which is 10 ms long when SFN increases by one. The offset may also be an offset in terms of the paging cycle.

Note 4: The parameters of PSM transmitted in the UE CONTEXT RELEASE COMMAND message may be an offset of the previously configured PSM parameters. Take FIG. 16 as an example of the offset for PSM configuration, the offset may be an offset of the timer T3324 or T3412. (e.g., offset_{T3324}, or offset _{T3412}).

Note 5: If the countdown timer for the eDRX/PSM configuration(s) validation is configured by the MME, the MME may update the countdown timer in the UE CONTEXT RELEASE COMMAND message.

Step 5: The eNB transmits RRCConnectionRelease message to the satellite to release the UE.

Note 1: The offset value may be a parameter on Access Stratum (AS) layer not on NAS layer. (i.e., not carried in NAS message).

Note 2: The RRCConnectionRelease message may comprise a ReleaseCause. (e.g., Discontinuous Coverage).

Note 3: If the countdown timer for the eDRX/PSM configuration(s) validation is configured by the eNB, the eNB may update the countdown timer in the RRC: RRCConnectionReconfiguration message.

Step 6: The satellite forwards the RRCConnectionRelease message to the UE.

Step 7: After receiving the RRCConnectionRelease message, the UE goes to RRC Idle and activates eDRX/PSM operation.

Note 1: When the offset value is an AS parameter, the UE may not update the eDRX/PSM configuration(s). The UE may activate a timer based on the received offset value. The UE may skip monitoring the paging before the timer expires.

Note 2: If the RRCConnectionRelease message includes an offset value (i.e., an offset value carried in the NAS message) for the PSM configuration, the timers T3324 and T3412 are updated according to FIG. 16.

Note3: If the RRCConnectionRelease message includes an offset value (i.e., an offset value carried in the NAS message) for the eDRX configuration, the UE may monitor the paging based on the offset value. The paging frame is updated as follows:

The Paging Hyperframe (PH) is the H-SFN satisfying the following equation: H-SFN_{old} mod T_{eDRX,H}=UE_ID_H mod T_{eDRX,H}→H-SFN_{new}=H-SFN_{old}+offset_{H-SFN}, where:

UE_ID_H: 10 or 12 most significant bits of the Hashed ID.

T_{eDRX,H}: eDRX cycle of the UE in Hyper-frames.

PTW_start denotes the first radio frame of the PH that is part of the PTW and has SFN

satisfying the following equation: SFN_{old}=256*i_{eDRX},→SFN_{new}=SFN_{old}+offset_{SFN}, where i_{eDRX}=floor(UE_ID_H/T_{eDRX,H}) mod 4.

PTW_end is the last radio frame of the PTW and has SFN satisfying the following equation: SFN_{old}=(PTW_start+L*100−1) mod 1024→SFN_{new}=SFN_{old}+offset_{SFN}, where L=PTW length (in seconds) configured by upper layers.

Note 4: When the UE receives the (updated) countdown timer for the eDRX/PSM configuration(s) validation, the UE activates the countdown timer for the eDRX/PSM configuration(s).

Updating eDRX/PSM configuration(s) by the eNB/MME when the UE is in RRC Idle/Inactive

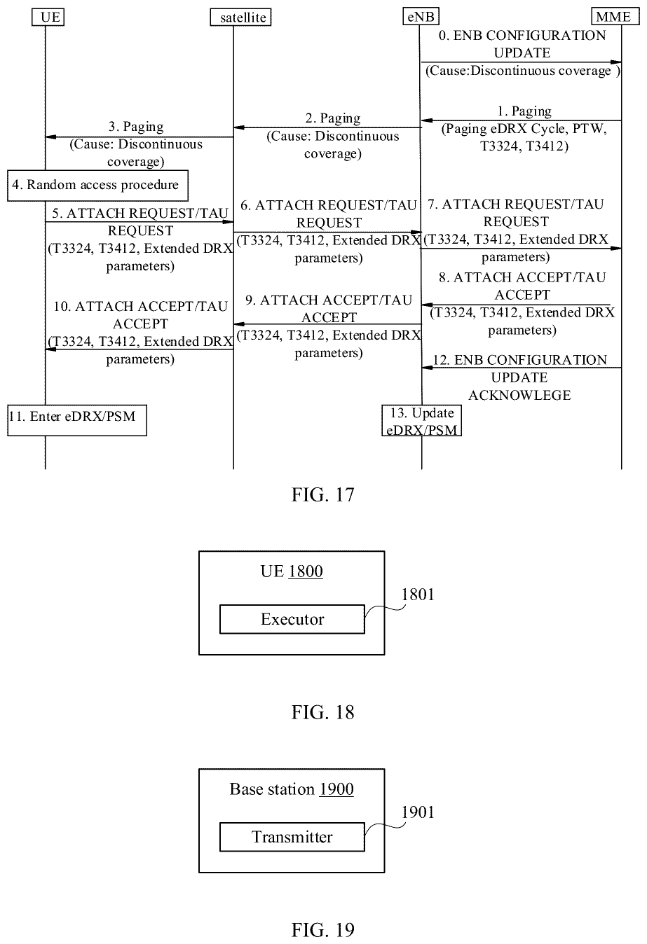

FIG. 17 shows the procedure of updating eDRX/PSM configuration(s) by paging the UE. In this embodiment, the eDRX/PSM configuration(s) modification is controlled by the eNB/MME.

The procedure of updating eDRX/PSM by paging the UE includes at least one of the followings.

Step 0: When the eNB determines that the eDRX/PSM periodicity needs to be modified to match the arrival time of the next satellite, the eNB transmits the S1AP: ENB CONFIGURATION UPDATE message to the MME. The ENB CONFIGURATION UPDATE message may carry the information including the service stop time of the serving satellite, the service start time of the next satellite, and the cause value, for example, ‘Discontinuous Coverage.’

Note 1: The MME may reply with the S1AP: ENB CONFIGURATION UPDAE ACKNOWLEDGE message.

Note 2: This step may be omitted in case the MME knows the arrival time of the (next) satellite(s).

Step 1: If the MME confirms the eDRX/PSM modification, the MME transmits the S1AP: PAGING message to the eNB. The PAGING message may include the updated parameters of paging eDRX cycle, PTW, timer T3324, and timer T3412.

Step 2: The eNB pages the UE using the original eDRX/PSM configuration(s). The RRC: paging message may carry the paging cause: Discontinuous Coverage.

Step 3: The satellite forwards the paging message to the UE.

Step 4: After being paged, the UE initiates the random access procedure to update the eDRX/PSM configuration(s).

Step 5: The UE transmits the NAS message: ATTACH REQUEST or TRACKING AREA UPDATE REQUEST message to the serving satellite. The ATTACH REQUEST or TRACKING

AREA UPDATE REQUEST message is carried in RRC: RRCConnectionSetupComplete or ULInformationTransfer message. The ATTACH REQUEST or TRACKING AREA UPDATE REQUEST message may include the parameters of eDRX/PSM such as PTW and T_{eDRX,H} for eDRX and T3324 and T3412 for PSM. The length of PTW or T3324 could be configured as the in-coverage interval of the serving satellite, and the length of T_{eDRX,H} and T3412 could be configured as the in-coverage interval plus the out-of-coverage interval. The out-of-coverage interval could be configured as the service start time of the next satellite minus the service stop time of the serving satellite.

Note 1: The NAS message: ATTACH REQUEST or TRACKING AREA UPDATE REQUEST message may include the service stop time of the serving satellite and service start time of the next satellite. The NAS message: ATTACH REQUEST or TRACKING AREA UPDATE REQUEST message may also include UE location information, cell identity, satellite identity, or satellite ephemeris. The information is for MME to determine the values of T3324 and T3412.

Note 2: The ATTACH REQUEST or TRACKING AREA UPDATE REQUEST message

may include the parameters of multiple eDRX/PSM configurations.

Step 6: The satellite forwards the ATTACH REQUEST or TRACKING AREA UPDATE REQUEST message to the eNB.

Note1: If the satellite is a regenerative satellite (i.e., the eNB is implemented on the satellite), this step could be omitted. If the satellite is a transparent satellite (i.e., the eNB is implemented on the ground and connect with the UE through the satellite), the satellite just forwards the ATTACH REQUEST or TRACKING AREA UPDATE REQUEST message to the eNB through the feeder link.

Step 7: The eNB forwards the ATTACH REQUEST or TRACKING AREA UPDATE REQUEST message to the MME. The ATTACH REQUEST or TRACKING AREA UPDATE REQUEST message is carried in the S1AP: Initial UE message.

Step 8: The MME replies with the ATTACH ACCEPT or TRACKING AREA UPDATE ACCEPT message to the eNB. The ATTACH ACCEPT or TRACKING AREA UPDATE ACCEPT message is carried in the S1AP: Initial Context Setup Request message. The ATTACH

ACCEPT or TRACKING AREA UPDATE ACCEPT message includes the parameters of eDRX/PSM (i.e., PTW and T_{eDRX,H} for eDRX and T3324 and T3412 for PSM) if the MME accepts the eDRX/PSM request from the UE.

Note 1: If the countdown timer for the eDRX/PSM configuration(s) validation is configured by the MME, the MME may transmit the (updated) countdown timer in the ATTACH ACCEPT or TRACKING AREA UPDATE ACCEPT message.

Step 9: The eNB forwards the ATTACH ACCEPT or TRACKING AREA UPDATE ACCEPT message to the satellite. The ATTACH ACCEPT or TRACKING AREA UPDATE ACCEPT message is carried in the RRC: RRCConnectionReconfiguration or DLInformation Transfer message.

Note 1: If the satellite is a regenerative satellite (i.e., the eNB is implemented on the satellite), this step could be omitted.

Note 2: If the countdown timer for the eDRX/PSM configuration(s) validation is configured by the eNB, the eNB may transmit the (updated) countdown timer in the RRC: RRCConnectionReconfiguration message.

Step 10: The satellite forwards the ATTACH ACCEPT or TRACKING AREA UPDATE ACCEPT message to the UE. The ATTACH ACCEPT or TRACKING AREA UPDATE ACCEPT message is carried in RRC: RRCConnectionReconfiguration or DLInformationTransfer message. After receiving the ATTACH ACCEPT message, the UE setups the eDRX/PSM configuration(s) for the default radio bearer.

Note 1: If the UE requests multiple eDRX/PSM configurations in step 2, the ATTACH ACCEPT or TRACKING AREA UPDATE ACCEPT message may include the parameters of multiple eDRX/PSM configurations.

Step 11: After receiving the ATTACH ACCEPT or TRACKING AREA UPDATE ACCEPT message, the UE updates the eDRX/PSM configuration(s).

Note 1: When the UE receives the (updated) countdown timer for the eDRX/PSM configuration(s) validation, the UE activates the countdown timer for the eDRX/PSM configuration(s).

Step 12: The MME reply to the eNB with the S1AP: ENB CONFIGURATION UPDAE ACKNOWLEDGE message.

Step 13: After receiving the ENB CONFIGURATION UPDAE ACKNOWLEDGE message, the eNB updates the eDRX/PSM configuration(s).

Note 1: The sequence of steps 12 and 13 is independent of steps 10 and 11. In other words, the steps 12 and 13 may be after or before the steps 10 and 11.

FIG. 18 is a block diagram of a UE 1800 for wireless communication according to an embodiment of the present disclosure. In some embodiments, the UE 1800 includes an executor 1801 configured to perform a power saving mechanism when the UE 1800 is in a discontinuous coverage scenario that includes alternating occurrences of an in-coverage and an out-of-coverage, wherein in the power saving mechanism, the UE 1800 is in a dormant state or in a power saving mode (PSM) during the out-of-coverage of the discontinuous coverage scenario, and the executor 1801 is configured to wake up to monitor a paging during the in-coverage of the discontinuous scenario. The dormant state may refer to a state in which the UE has no data to be transmitted during the out-of-coverage of the discontinuous coverage scenario. This can solve issues in the prior art, provide a non-terrestrial communication for Narrowband Internet of Things (NB-IoT), provide a power saving for discontinuous coverage in a IoT non-terrestrial network (NTN), provide a good communication performance, and/or provide high reliability. The UE could be dormant during the out-of-coverage and wake up to monitor the paging during the in-coverage.

In some embodiments, the UE in the discontinuous coverage scenario includes the UE is in a radio resource control (RRC) connected state from the in-coverage to the out-of-coverage, the UE is in the RRC connected state from the out-of-coverage to the in-coverage, the UE is in an RRC idle state or an RRC inactive state from the in-coverage to the out-of-coverage, or the UE is in an RRC idle state or an RRC inactive state from the out-of-coverage to the in-coverage. In some embodiments, when the UE is in the RRC connected state from the in-coverage to the out-of-coverage, the UE performing the power saving mechanism includes reducing a measurement latency of a serving cell for the UE, avoiding the UE continuously performing a cell selection before re-establishing a connection, and/or reducing a latency of the cell selection. In some embodiments, the UE reducing the measurement latency of the serving cell includes the UE reducing or early stopping a first timer based on information from a satellite to reduce a recovery time for the serving cell or the UE adopting a second timer shorter than the first timer based on the information from the satellite to reduce the recovery time for the serving cell.

In some embodiments, if the serving cell is a quasi-earth fixed cell, the information from the satellite includes a service stop time of a serving satellite, a leaving indication, a service start time of a next satellite, a physical cell identity, a satellite identity, or a satellite ephemeris of the serving satellite, and/or a physical cell identity, a satellite identity, or a satellite ephemeris of the next satellite. In some embodiments, if the serving cell is a moving cell, the information from the satellite includes the service stop time of the serving satellite, the leaving indication, the service start time of the next satellite, an ephemeris information, a reference location of the serving cell, an elevation angle, a maximum distance, a cell footprint size, a physical cell identity, a satellite identity, or a satellite ephemeris of the serving satellite, and/or a physical cell identity, a satellite identity, or a satellite ephemeris of the next satellite. In some embodiments, the information from the satellite is transmitted by a base station to the UE through a broadcast message or a unicast message. In some embodiments, avoiding the UE continuously performing the cell selection before re-establishing the connection or reducing the measurement time is based on information of an arrival time of the next satellite or parameters of an extended discontinuous reception (eDRX) and/or the PSM. In some embodiments, the information of the arrival time of the next satellite is transmitted by the base station to the UE through the broadcast message or the unicast message. In some embodiments, the parameters of the eDRX and/or the PSM includes a paging time window (PTW), an eDRX cycle, a T3324 timer, ant/or a T3412 timer.

In some embodiments, the parameters of the eDRX and/or the PSM are updatable based on new parameters or an offset. In some embodiments, the parameters of the eDRX and/or the PSM are transmitted from the base station to the UE through the unicast message. In some embodiments, the unicast message includes an RRCConnectionReconfiguration message, a

DLInformationTransfer message, or an RRCConnectionRelease message. In some embodiments, after the UE receives the RRCConnectionRelease message from the base station, the UE activates the eDRX or the PSM configurations and stops performing cell selection measurements during an out-of-coverage interval. In some embodiments, reducing the latency of the cell selection is based on information of a next satellite. In some embodiments, the information of the next satellite is transmitted by the base station to the UE through the broadcast message or the unicast message. In some embodiments, for the unicast message, the UE is configured to receive cell identities or satellite identity of the next satellite through the RRCConnectionRelease message. In some embodiments, for the broadcast message, the UE is configured to receive the information of the next satellite through a system information.

In some embodiments, the system information includes SystemInformationBlockType4 or SystemInformationBlockType5. In some embodiments, when the UE is in the RRC idle state or the RRC inactive state from the in-coverage to the out-of-coverage, the UE performing the power saving mechanism includes at least one of the followings: the UE monitoring the paging from the base station to receive a reconfiguration of parameters of one or more eDRX and/or the PSM configurations for the UE (in this case, the UE enters the RRC connected state to receive the updated parameters of eDRX/PSM); the UE receiving, from the base station, the service stop time of the serving satellite and/or the service start time of the next satellite (in this case, the UE stays in the RRC idle/inactive state to receive the service stop/start time from the SIB); the UE receiving, from the base station, one or more eDRX configurations and/or one or more PSM configurations (in this case, the UE is configured with multiple eDRX/PSM configurations in advance, and the UE could stay in RRC idle/inactive state); and the UE receiving, from the base station, one or more offsets of the one or more eDRX configurations and/or the one or more PSM configurations (in this case, if the offsets are broadcasted by the base station, the UE stays in RRC idle/inactive state).

In some embodiments, the UE is configured to monitor the paging from the base station during an in-coverage interval, such that the UE is configured to enter the RRC connected state. In some embodiments, the parameters of the eDRX and/or the PSM are transmitted from the base station to the UE through an RRCConnectionReconfiguration message, a DLInformationTransfer message, or an RRCConnectionRelease message. In some embodiments, when the UE determines that the one or more eDRX configurations and/or the one or more PSM configurations need to be modified based on a timer, the service stop time of the serving satellite and/or the service start time of the next satellite, the UE requests new parameters or one or more offsets of the parameters of the eDRX and/or the PSM to the base station or the MME through an RRCConnectionSetupComplete message, an ULInformationTransfer message, or a UEAssistanceInformation message. In some embodiments, the one or more offsets of the parameters of the one or more eDRX configurations and/or the one or more PSM configurations includes one or more non-access stratum (NAS) level parameters.

In some embodiments, a cycle of the eDRX and/or the PSM configuration is modified to an initial period plus an offset when the UE is in the in-coverage, such that an on period and an off period of the one eDRX configuration and/or the one PSM configuration match the in-coverage interval and the out-of-coverage interval, respectively. In some embodiments, when the UE receives, from the base station, the service stop time of the serving satellite and/or the service start time of the next satellite, the UE stays in the RRC idle state or the RRC inactive state and monitors a control information from the base station. In some embodiments, the UE is configured to calculate or update the cycle of the eDRX and/or the PSM using the service stop time of the serving satellite and/or the service start time of the next satellite. In some embodiments, the eDRX configurations and/or the PSM configurations are configured for a same satellite or for different satellites with different out-of-coverage intervals. In some embodiments, the one or more offsets of the parameters of the one or more eDRX configurations and/or the one or more PSM configurations includes a common offset of the parameters of the one or more eDRX configurations and/or the one or more PSM configurations for the UE in a specific area.

In some embodiments, the common offset includes a first timing offset of an eDRX PTW or PSM timer T3324 for the serving satellite or a second timing offset of the eDRX PTW or PSM timer T3324 for the next satellite, and a value of the first timing offset and/or a value of the second timing offset is positive or negative. In some embodiments, the common offset includes an AS level parameter. In some embodiments, based on the common offset from the serving satellite, the UE in the specific area is configured to extend or shorten the eDRX PTW or PSM timer T3324 for the serving satellite without entering the RRC connected state, and/or the UEs is configured to extend or shorten the eDRX PTW or PSM timer T3324 for the next satellite based on the common offset for the next satellite. In some embodiments, the eDRX configurations and/or the PSM configurations includes one or more initial configurations of the eDRX and/or the PSM and one or more updating configurations of the eDRX and/or the PSM. In some embodiments, the one or more updating configurations of the eDRX and/or the PSM are initiated by the UE, by the base station, or by a mobility management entity (MME).

In some embodiments, a procedure of one or more initial configurations of the eDRX and/or the PSM through an initial attach includes at least one of the following steps: the UE receiving a broadcast system information from the base station; the UE completing a random access procedure based on the service stop time of the serving satellite, or otherwise if there is not enough time to complete the random access procedure, the UE avoids starting the random access procedure; the UE transmitting an NAS message including an attach request message to the serving satellite; the UE receiving an attach accept message from the serving satellite; the UE receiving an RRCConnectionRelease message from the serving satellite; and after receiving the RRCConnectionRelease message, the UE goes to the RRC idle state or the RRC inactive state and activates an operation of the eDRX and/or the PSM.

In some embodiments, the attach request message is carried in an RRC message. In some embodiments, the RRC message includes an RRCConnectionSetupComplete message or an ULInformationTransfer message. In some embodiments, the attach request message includes the parameters of the eDRX and/or the PSM, parameters of multiple eDRX configurations and/or PSM configurations, the service stop time of the serving satellite, the service start time of the next satellite, a UE location information, a cell identity, a satellite identity, and/or a satellite ephemeris. In some embodiments, the parameters of the eDRX and/or the PSM includes the PTW and a T_{eDRX,H} timer for the eDRX and T3324 and T3412 timers for the PSM. In some embodiments, a length of the PTW and/or a length of the T3324 timer is configured as the in-coverage interval of the serving satellite, and/or a length of the T_{eDRX,H} timer and/or a length of the T3412 timer is configured as the in-coverage interval plus the out-of-coverage interval. In some embodiments, the out-of-coverage interval is configured as the service start time of the next satellite minus the service stop time of the serving satellite. In some embodiments, the attach request message is used for the MME to determine values of the T3324 and T3412 timers. In some embodiments, the attach accept message is carried in the RRC message including an RRCConnectionReconfiguration message or a DLInformationTransfer message. In some embodiments, after receiving the attach accept message, the UE setups the one or more eDRX configurations and/or the one or more PSM configurations for a default radio bearer.

In some embodiments, a procedure of the one or more updating configurations of the eDRX and/or the PSM includes at least one of the following steps: the UE receiving the broadcast system information from the base station; when the UE determines that the service stop time of the serving satellite is outside an active time of a current periodicity of the eDRX and/or the PSM or the service start time of the next satellite is outside an active time of a next periodicity of the eDRX and/or the PSM, the UE initiates the random access procedure to update the one or more eDRX configurations and/or the one or more PSM configurations, or otherwise if there is not enough time to complete the random access procedure, the UE avoids starting the random access procedure; the UE transmitting an NAS message including a tracking area update request message to the serving satellite; the UE receiving a tracking area update accept message from the serving satellite; the UE receiving an RRCConnectionRelease message from the serving satellite; and after receiving the RRCConnectionRelease message, the UE goes to the RRC idle state or the RRC inactive state and activates the operation of the eDRX and/or the PSM using the one or more updating configurations of the eDRX and/or the PSM.

In some embodiments, the tracking area update request message is carried in an RRC message. In some embodiments, the RRC message includes an RRCConnectionSetupComplete message or an ULInformationTransfer message. In some embodiments, the tracking area update request message includes updated parameters of the eDRX and/or the PSM, parameters of multiple eDRX configurations and/or PSM configurations, the service stop time of the serving satellite, the service start time of the next satellite, a UE location information, a cell identity, a satellite identity, and/or a satellite ephemeris. In some embodiments, the updated parameters of the eDRX and/or the PSM includes the PTW and the T_{eDRX,H} timer for the eDRX and T3324 and T3412 timers for the PSM. In some embodiments, the tracking area update request message is used for the MME to determine values of the T3324 and T3412 timers.

FIG. 19 is a block diagram of a base station 1900 for wireless communication according to an embodiment of the present disclosure. In some embodiments, the base station 1900 includes an transmitter 1901 configured to transmit a power saving information for a user equipment (UE) in a discontinuous coverage scenario that includes alternating occurrences of an in-coverage and an out-of-coverage such that the UE can be in a dormant state or in a power saving mode (PSM) during the out-of-coverage of the discontinuous scenario and wakes up to monitor a paging during the in-coverage of the discontinuous scenario. The dormant state may refer to a state in which the UE has no data to be transmitted during the out-of-coverage of the discontinuous coverage scenario. This can solve issues in the prior art, provide a non-terrestrial communication for Narrowband Internet of Things (NB-IoT), provide a power saving for discontinuous coverage in a IoT non-terrestrial network (NTN), provide a good communication performance, and/or provide high reliability. The UE could be dormant during the out-of-coverage and wake up to monitor the paging during the in-coverage.

In some embodiments, when the base station detects the UE in the RRC connected state from the in-coverage to the out-of-coverage, the base station performing the power saving mechanism includes reducing a measurement latency of a serving cell for the UE, avoiding the UE continuously performing a cell selection before re-establishing a connection, and/or reducing a latency of the cell selection.

In some embodiments, if the serving cell is a quasi-earth fixed cell, the information from the satellite includes a service stop time of a serving satellite, a leaving indication, a service start time of a next satellite, a physical cell identity, a satellite identity, or a satellite ephemeris of the serving satellite, and/or a physical cell identity, a satellite identity, or a satellite ephemeris of the next satellite. In some embodiments, if the serving cell is a moving cell, the information from the satellite includes the service stop time of the serving satellite, the leaving indication, the service start time of the next satellite, an ephemeris information, a reference location of the serving cell, an elevation angle, a maximum distance, a cell footprint size, a physical cell identity, a satellite identity, or a satellite ephemeris of the serving satellite, and/or a physical cell identity, a satellite identity, or a satellite ephemeris of the next satellite. In some embodiments, the information from the satellite is transmitted by the base station to the UE through a broadcast message or a unicast message.

In some embodiments, the information of the arrival time of the next satellite is transmitted by the base station to the UE through the broadcast message or the unicast message. In some embodiments, the base station is configured to transmit the parameters of the eDRX and/or the PSM configurations before releasing the UE, and then releases the UE based on the service stop time of the serving satellite, and indicates the UE to activate the eDRX or the PSM configurations to stop performing cell selection measurements during an out-of-coverage interval.

In some embodiments, reducing the latency of the cell selection is based on information of a next satellite. In some embodiments, the information of the next satellite is transmitted by the base station to the UE through the broadcast message or the unicast message. In some embodiments, for the unicast message, the base station is configured to transmit, to the UE, cell identities or satellite identity of the next satellite through the RRCConnectionRelease message. In some embodiments, for the broadcast message, the base station is configured to transmit, to the UE, the information of the next satellite through a system information. In some embodiments, the system information includes SystemInformationBlockType4 or SystemInformationBlockType5.

In some embodiments, when the UE is in the RRC idle state or the RRC inactive state, the base station performing the power saving mechanism comprises at least one of the followings: the base station paging the UE to re-configure the parameters of one or more eDRX and/or the PSM configurations for the UE; the base station broadcasting, to the UE, the service stop time of the serving satellite and/or the service start time of the next satellite; the base station configurating, to the UE, one or more eDRX configurations and/or one or more PSM configurations; and the base station configuration, to the UE, one or more offsets of the parameters of the one or more eDRX configurations and/or the one or more PSM configurations. In some embodiments, the base station is configured to page the UE during an in-coverage interval to control the UE to enter the RRC connected state.

In some embodiments, the one or more offsets of the parameters of the one or more eDRX configurations and/or the one or more PSM configurations includes a common offset of the parameters of the one or more eDRX configurations and/or the one or more PSM configurations for the UE in a specific area. In some embodiments, the common offset includes a first timing offset of an eDRX PTW or PSM timer T3324 for the serving satellite or a second timing offset of the eDRX PTW or PSM timer T3324 for the next satellite, and a value of the first timing offset and/or a value of the second timing offset is positive or negative. In some embodiments, the common offset includes an AS level parameter. In some embodiments, based on the common offset from the serving satellite, the base station is configured to indicate the UE in the specific area to extend or shorten the eDRX PTW or PSM timer T3324 for the serving satellite without entering the RRC connected state, and/or the base station is configured to indicate the UE to extend or shorten the eDRX PTW or PSM timer T3324 for the next satellite based on the common offset for the next satellite. In some embodiments, the eDRX configurations and/or the PSM configurations includes one or more initial configurations of the eDRX and/or the PSM and one or more updating configurations of the eDRX and/or the PSM. In some embodiments, the one or more updating configurations of the eDRX and/or the PSM are initiated by the UE, by the base station, or by a mobility management entity (MME).

In some embodiments, a procedure of one or more initial configurations of the eDRX and/or the PSM through an initial attach includes at least one of the following steps: the base station transmitting a broadcast system information to the UE; the base station receiving an NAS message including an attach request message from the serving satellite; the base station forwarding the NAS message including the attach request message to the MME; the base station receiving an attach accept message from the MME; the base station forwarding the attach accept message to the serving satellite; after data transmission, the base station transmits a UE context release request message with a cause value of a user inactivity to the MME to initiate to release a radio bearer for the UE; the base station receiving a UE context release command message to release the UE from the MME; and the base station transmitting an RRCConnectionRelease message to the serving satellite to release the UE.

In some embodiments, a procedure of the one or more updating configurations of the eDRX and/or the PSM includes at least one of the following steps: the base station transmitting the broadcast system information to the UE; the base station performing data transmission to/from the UE; after the data transmission, the base station transmits a UE context release request message with a cause value of a user inactivity to the MME to initiate to release a radio bearer for the UE; the base station receiving a UE context release command message to release the UE from the MME; and the base station transmitting an RRCConnectionRelease message to the serving satellite to release the UE.

In some embodiments, a procedure of the one or more updating configurations of the eDRX and/or the PSM includes at least one of the following steps: when the base station determines that a periodicity of the eDRX and/or the PSM needs to be modified to match the arrival time of the next satellite, the base station transmits an ENB configuration update message to the MME; if a modification of the eDRX and/or the PSM is confirmed, the base station receives a paging message from the MME; the base station paging the UE to use original one or more eDRX configurations and/or original one or more PSM configurations; the base station receiving the attach request message or a tracking area updated request message from the serving satellite; the base station forwarding the attach request message or a tracking area updated request message to the MME; the base station receiving the attach accept message or a tracking area updated accept message from the MME; the base station receiving an ENB configuration update acknowledge message from the MME; after receiving the ENB configuration update acknowledge message, the base station updates the one or more eDRX configurations and/or the one or more PSM configurations.

In some embodiments, the ENB configuration update message carry information including the service stop time of the serving satellite, the service start time of the next satellite, and a cause value. In some embodiments, the paging message includes updated parameters of a paging eDRX cycle, the PTW, the T3324 timer, and the T3412 timer. In some embodiments, the attach accept message or the tracking area updated accept message is carried in an initial context setup request message, the attach accept message or the tracking area updated accept message includes parameters of the eDRX and/or the PSM, and/or the attach accept message or the tracking area updated accept message is carried in an RRC message. In some embodiments, the UE context release command message and/or the tracking area update request message is carried in an RRC message. In some embodiments, the RRC message includes an RRCConnectionSetupComplete message or an ULInformationTransfer message. In some embodiments, the UE context release command message and/or the tracking area update request message includes updated parameters of the eDRX and/or the PSM, parameters of multiple eDRX configurations and/or PSM configurations, the service stop time of the serving satellite, the service start time of the next satellite, a UE location information, a cell identity, a satellite identity, and/or a satellite ephemeris. In some embodiments, the updated parameters of the eDRX and/or the PSM includes the PTW and T_{eDRX,H} for the eDRX and T3324 and T3412 timers for the PSM. In some embodiments, the UE context release command message and/or the tracking area update request message is used for the MME to determine values of the T3324 and T3412 timers.

### SUMMARY OF THE EMBODIMENTS

1. The UE is in RRC connected state from in-coverage to out-of-coverage. One of the followings is formed.

a. Reducing the measurement latency of the serving cell for the UE.

b. Avoiding the UE continuously performing cell (re)selection before re-establishing the connection or reducing the measurement time.

c. Reducing the latency of cell (re)selection.

2. The UE is in RRC Idle/Inactive state from in-coverage to out-of-coverage. One of the followings is formed.

a. The eNB pages the UE to re-configure the eDRX/PSM parameters for the UE.

b. The eNB broadcast service stop time of serving satellite and/or service start time of next satellite.

c. The eNB configures the UE with multiple eDRX/PSM configurations.

3. The procedures of eDRX/PSM configuration(s) for a UE.

a. Initial configuration(s) of eDRX/PSM.

b. Updating configuration(s) of eDRX/PSM.

i) Updating eDRX/PSM configuration(s) by the UE.

ii) Updating eDRX/PSM configuration(s) by the eNB/MME.

iii) Updating eDRX/PSM configuration(s) by the eNB/MME when the UE is in RRC Idle/Inactive.

Commercial interests for some embodiments are as follows. 1. Solve issues in the prior art. 2. Provide a non-terrestrial communication for Narrowband Internet of Things (NB-IoT). 3. Provide a power saving for discontinuous coverage in a IoT non-terrestrial network (NTN). 4. Provide a good communication performance. 5. Provide high reliability. 6. The UE could be dormant during the out-of-coverage and wake up to monitor the paging during the in-coverage. 7. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR licensed and non-licensed or shared spectrum communications. Some embodiments of the present disclosure propose technical mechanisms.

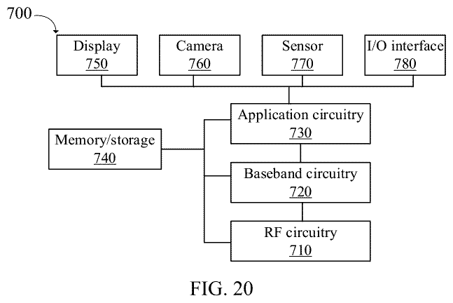

FIG. 20 is a block diagram of an example system 700 for wireless communication according to an embodiment of the present disclosure. Embodiments described herein may be implemented into the system using any suitably configured hardware and/or software. FIG. 20 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency. The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC). The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface. In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, an AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms. The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method performed by a user equipment (UE), comprising:
performing a power saving mechanism when the UE is in a discontinuous coverage scenario that comprises alternating occurrences of an in-coverage and an out-of-coverage, wherein in the power saving mechanism, the UE is in a dormant state or in a power saving mode (PSM) during the out-of-coverage of the discontinuous coverage scenario and is configured to wake up to monitor a paging during the in-coverage of the discontinuous scenario;
wherein an out-of-coverage interval is configured based on a service stop time of a serving satellite and/or a service start time of a next satellite; and
wherein the service stop time of the serving satellite and the service start time of the next satellite is determined based on an information from a satellite.

2-3. (canceled)

4. The wireless communication method performed by the UE according to claim 1, wherein the UE reducing the measurement latency of the serving cell comprises the UE reducing or early stopping a first timer based on information from a satellite to reduce a recovery time for the serving cell.

5. The wireless communication method performed by the UE according to claim 1, wherein if the serving cell is a quasi-earth fixed cell, the information from the satellite comprises a service stop time of a serving satellite, a leaving indication, a service start time of a next satellite, a physical cell identity, a satellite identity, or a satellite ephemeris of the serving satellite, and/or a physical cell identity, a satellite identity, or a satellite ephemeris of the next satellite.

6. The wireless communication method performed by the UE according to claim 1, wherein if the serving cell is a moving cell, the information from the satellite comprises a reference location of the serving cell, an elevation angle, a maximum distance, a cell footprint size, a physical cell identity, a satellite identity, or a satellite ephemeris of the serving satellite, and/or a physical cell identity, a satellite identity, or a satellite ephemeris of the next satellite.

7. The wireless communication method performed by the UE according to claim 1, wherein the information from the satellite is transmitted by a base station to the UE through a broadcast message or a unicast message.

8-34. (canceled)

35. The wireless communication method performed by the UE according to claim 1, wherein a procedure of one or more initial configurations of the eDRX and/or the PSM through an initial attach comprises at least one of the following steps:
the UE transmitting an attach request message comprising the out-of-coverage interval to a mobility management entity (MME) when the UE determines that there is enough time to complete the eDRX and/or PSM configuration;
the UE receiving an attach accept message from the serving satellite;
the UE activates an operation of the eDRX and/or the PSM.

36-37. (canceled)

38. The wireless communication method performed by the UE according to claim 35, wherein the attach request message comprises the parameters of the eDRX and/or the PSM, parameters of multiple eDRX configurations and/or PSM configurations, the service stop time of the serving satellite, the service start time of the next satellite, a UE location information, a cell identity, a satellite identity, and/or a satellite ephemeris.

39. The wireless communication method performed by the UE according to claim 38, wherein the parameters of the eDRX and/or the PSM comprises a PTW and a T_{eDRX,H} timer for the eDRX and T3324 and T3412 timers for the PSM.

40. The wireless communication method performed by the UE according to claim 39, wherein a length of the PTW and/or a length of the T3324 timer is configured as the in-coverage interval of the serving satellite, and/or a length of the T_{eDRX,H} timer and/or a length of the T3412 timer is configured as the in-coverage interval plus the out-of-coverage interval.

41-44. (canceled)

45. The wireless communication method performed by the UE according to claim 1, wherein a procedure of the one or more updating configurations of the eDRX and/or the PSM comprises at least one of the following steps:
the UE transmitting a tracking area update request message comprising the updated out-of-coverage interval to a mobility management entity (MME) when the UE determines that there is enough time to update the eDRX and/or PSM configuration;
the UE receiving a tracking area update accept message from the serving satellite; the UE activates the operation of the eDRX and/or the PSM using the updating configurations of the eDRX and/or the PSM.

46-47. (canceled)

48. The wireless communication method performed by the UE according to claim 45, wherein the tracking area update request message comprises updated parameters of the eDRX and/or the PSM, parameters of multiple eDRX configurations and/or PSM configurations, the service stop time of the serving satellite, the service start time of the next satellite, a UE location information, a cell identity, a satellite identity, and/or a satellite ephemeris.

49. The wireless communication method performed by the UE according to claim 48, wherein the updated parameters of the eDRX and/or the PSM comprises a PTW and a T_{eDRX,H} timer for the eDRX and T3324 and T3412 timers for the PSM.

50. The wireless communication method performed by the UE according to claim 45, wherein the tracking area update request message is used for the MME to determine values of the T3324 and T3412 timers.

51. A wireless communication method performed by a base station, comprising:
transmitting an information for a user equipment (UE) in a discontinuous coverage scenario that comprises alternating occurrences of an in-coverage and an out-of-coverage such that the UE can be in a dormant state or in a power saving mode (PSM) during the out-of-coverage of the discontinuous scenario and wakes up to monitor a paging during the in-coverage of the discontinuous scenario;
wherein an out-of-coverage interval is configured based on a service stop time of a serving satellite and/or a service start time of a next satellite; and
wherein the service stop time of the serving satellite and the service start time of the next satellite is determined based on the information from the base station.

52. (canceled)

53. The wireless communication method performed by the base station according to claim 51, wherein if the serving cell is a quasi-earth fixed cell, the information from the base station comprises a service stop time of a serving satellite, a leaving indication, a service start time of a next satellite, a physical cell identity, a satellite identity, or a satellite ephemeris of the serving satellite, and/or a physical cell identity, a satellite identity, or a satellite ephemeris of the next satellite.

54. The wireless communication method performed by the base station according to claim 51, wherein if the serving cell is a moving cell, the information from the base station comprises a reference location of the serving cell, an elevation angle, a maximum distance, a cell footprint size, a physical cell identity, a satellite identity, or a satellite ephemeris of the serving satellite, and/or a physical cell identity, a satellite identity, or a satellite ephemeris of the next satellite.

55. The wireless communication method performed by the base station according to claims 51, wherein the information is transmitted by the base station to the UE through a broadcast message or a unicast message.

56-70. (canceled)

71. The wireless communication method performed by the base station according to claim 51, wherein a procedure of one or more initial configurations of the eDRX and/or the PSM through an initial attach comprises at least one of the following steps:
the base station receiving an attach request message comprising the out-of-coverage interval from the UE through the serving satellite;
the base station forwarding the attach request message to the MME;
the base station receiving an attach accept message from the MME;
the base station forwarding the attach accept message comprising the out-of-coverage interval to the UE through the serving satellite;
the base station transmits a UE context release request message to the MME to initiate to release a radio bearer for the UE;
the base station receiving a UE context release command message to release the UE from the MME; and
the base station transmitting an RRCConnectionRelease message to UE through the serving satellite to release the UE.

72. (canceled)

73. The wireless communication method performed by the base station according to claim 51, wherein a procedure of the one or more updating configurations of the eDRX and/or the PSM comprises at least one of the following steps:
the base station receiving a tracking area update request message comprising the updated out-of-coverage interval from the UE through the serving satellite;
the base station forwarding the tracking area update request message to the MME;
the base station receiving a tracking area update accept message from the MME;
the base station forwarding the tracking area update accept message comprising the updated out-of-coverage interval to the UE through the serving satellite;
the base station transmits a UE context release request message to the MME to initiate to release a radio bearer for the UE;
the base station receiving a UE context release command message to release the UE from the MME; and
the base station transmitting an RRCConnectionRelease message to the UE through the serving satellite to release the UE.

74-84. (canceled)

85. A user equipment (UE), comprising:
a memory;
a transceiver; and
a processor coupled to the memory and the transceiver;
wherein the processor is configured to perform a power saving mechanism when the UE is in a discontinuous coverage scenario that comprises alternating occurrences of an in-coverage and an out-of-coverage, wherein in the power saving mechanism, the UE is in a dormant state or in a power saving mode (PSM) during the out-of-coverage of the discontinuous coverage scenario, and the processor is configured to wake up to monitor a paging during the in-coverage of the discontinuous scenario,
wherein an out-of-coverage interval is configured based on a service stop time of a serving satellite and/or a service start time of a next satellite; and
wherein the service stop time of the serving satellite and the service start time of the next satellite is determined based on an information from a satellite.

86-91. (canceled)
